(19) United States
(12) Patent Application Publication
(10) Pub. No.: US 2008/0013642 A1
(43) Pub. Date: Jan. 17, 2008

(54) APPARATUS AND METHOD FOR SELECTING CODING SCHEME IN A MIMO SYSTEM

(75) Inventors: Seung-Hoon Nam, Seoul (KR); Dae-Young Park, Seoul (KR); Chung-Yong Lee, Seoul (KR); Jae-Sang Ham, Yongin-si (KR); Kyeong-Yeon Kim, Seoul (KR); Bal-Geum Chol, Bucheon-si (KR)

Correspondence Address: Jefferson IP Law, LLP, 1730 M Street, NW, Suite 807, Washington, DC, 20036, US

(73) Assignees: Samsung Electronics Co., LTD., Suwon-city (KR); Industry-Academic Cooperation Foundation, Yonsei University, Seoul (KR)

(21) Appl. No.: 11/777,361

(22) Filed: Jul. 13, 2007

(30) Foreign Application Priority Data
Jul. 13, 2006 (KR) 2006-0065784

(51) Int. Cl. H04B 7/02

(52) U.S. Cl. 375/267

(57) ABSTRACT

An apparatus and method for selecting a Space-Time Coding (STC) scheme in a Multiple-Input Multiple-Output (MIMO) system are provided. Upon generation of a data transmission event, a transmitter receives a feedback signal, encodes transmission data using an STC scheme indicated by the feedback signal, and transmits the code symbols to a receiver, and the receiver measures interference factors of available STC schemes using the received code symbols, selects an STC scheme with a smaller interference factor, and notifies the transmitter of the selected STC scheme by a feedback signal.

### PRIORITY

This application claims the benefit under 35 U.S.C. §119(a) to a Korean patent application filed on Jul. 13, 2006 in the Korean Intellectual Property Office and assigned Serial No. 2006-65784, the entire disclosure of which is hereby incorporated by reference.

### JOINT RESEARCH AGREEMENT

The claimed invention was made by, on behalf of, and/or in connection with one or more of the following parties to a joint university-corporation research agreement: Samsung Electronics Corp. Ltd. and Industry-Academic Cooperation Foundation of Yonsei University. The agreement was in effect on and before the date the claimed invention was made, and the claimed invention was made as a result of activities undertaken within the scope of the agreement.

### BACKGROUND OF THE INVENTION

1. Field of the Invention

The present invention relates generally to a Multiple-Input Multiple-Output (MIMO) system. More particularly, the present invention relates to an apparatus and method for improving spatial diversity by selecting a Space-Time Coding (STC) scheme in a MIMO system.

2. Description of the Related Art

The recent rapid growth in the wireless mobile communication market has brought about the demand for a variety of multimedia services in a wireless environment, especially for high-speed transmission of a large amount of data. In this context, studies have been conducted on deploying a high-speed, high-reliability communication system that offers a maximal data rate and a minimal error rate with limited radio resources. A new transmission technology using multiple antennas is required to design such a high-speed, high-reliability communication system. An example of multi-antenna transmission technology is MIMO.

A MIMO system uses multiple antennas in both a transmitter and a receiver. Compared to a Single-Input Single-Output (SISO) system, the MIMO system can increase channel transmission capacity in proportion to the number of antennas without additional frequency or transmit power allocation. Accordingly, MIMO is a recent active study area.

MIMO technologies are categorized into spatial diversity that increases transmission reliability by achieving a diversity gain being the product of the number of transmit antennas and that of receive antennas, Spatial Multiplexing (SM) that increases data rate by transmitting a plurality of signal streams simultaneously, and a combination of spatial diversity and SM.

The spatial diversity scheme achieves a diversity effect in proportion to the product of the number of transmit antennas and receive antennas by use of Space-Time Block Coding (STBC). Therefore, reception performance is increased.

The SM scheme transmits different information data through a plurality of transmit antennas. The SM scheme can increase channel capacity by as much as the number of the transmit antennas in the MIMO system, compared to the SISO system. Therefore, system throughput is increased.

A major spatial diversity scheme that achieves a transmit diversity gain is Space Time Transmit Diversity (STTD). In STTD, one symbol is transmitted through two transmit antennas by orthogonal STC during one unit time, thus resulting in a full diversity gain. However, for three or more transmit antennas, STTD suffers from loss in data rate. Specifically, for four transmit antennas, STTD achieves a full diversity gain, but transmits no more than 3/4 of the symbol during one unit time. To overcome the resulting data rate loss, quasi-orthogonal STC has been proposed.

Quasi-orthogonal STC maintains a data rate to be one symbol for one unit time, causing loss in terms of diversity. For four transmit antennas and one receive antenna, a conventional quasi-orthogonal STC scheme transmits four symbols during four symbol intervals, that is one symbol per unit time, but achieves a maximal diversity gain of 2 being a half of the number of transmit antennas. In relation to the quasi-orthogonal STC scheme, a receiver uses a Maximum Likelihood (ML) detector. This phenomenon occurs in the process of eliminating data rate loss, while increasing the number of transmit antennas.

Two major quasi-orthogonal STCs are ABBA and Jafarkhani codes, which are expressed respectively along an antenna axis and a time axis as

$${C}_{ABBA} = [ \begin{matrix}{x}_{1} & {x}_{2} & {x}_{3} & {x}_{4} \\ - {x}_{2}^{*} & {x}_{1}^{*} & - {x}_{4}^{*} & {x}_{3}^{*} \\ {x}_{3} & {x}_{4} & {x}_{1} & {x}_{2} \\ - {x}_{4}^{*} & {x}_{3}^{*} & - {x}_{2}^{*} & {x}_{1}^{*}\end{matrix} ] \\ {C}_{jafarkhani} = [ \begin{matrix}{x}_{1} & {x}_{2} & {x}_{3} & {x}_{4} \\ - {x}_{2}^{*} & {x}_{1}^{*} & - {x}_{4}^{*} & {x}_{3}^{*} \\ - {x}_{3}^{*} & - {x}_{4}^{*} & {x}_{1}^{*} & {x}_{2}^{*} \\ {x}_{4} & - {x}_{3} & - {x}_{2} & {x}_{1}\end{matrix} ] \qquad ( 1 )$$

where C_{ABBA} denotes the ABBA code, C_{jafarkhani} denotes the Jafarkhani code, and xᵢ (i=1, 2, 3, 4) denotes a transmission symbol.

For the ABBA scheme, refer to O. Tirkkonen, A. Boariu, and A. Hottinen, “Minimal Non-Orthogonality Rate 1 Space-Time Block Code for 3+ Tx antennas”, in Proc. IEEE ISSSTA, vol. 2, pp. 429-432, September 2000, and for the Jafarkhani scheme, refer to H. Jafarkhani, “A Quasi-Orthogonal Space-Time Block Code”, IEEE Transaction on Communications, vol. 49, pp. 1-4, January 2001.

FIG. 1 illustrates a conventional MIMO system. Referring to FIG. 1, the conventional MIMO system includes a transmitter 100 and a receiver 110.

The transmitter 100 has an encoder 102 and a plurality of antennas 104. The encoder 102 encodes symbols using the ABBA code or the Jafarkhani code such that four symbols can be transmitted through four transmit antennas 104 during four time slots, and then transmits the code symbols through the antennas 104.

The receiver 110 includes an antenna 112, a channel estimator 114, and a detector 116. The antenna 112 receives a signal that has experienced fading channels. The channel estimator 114 estimates the channels of the received signal and configures valid channels using the ABBA code or the Jafarkhani code according to the channel estimates.

The detector 116 simultaneously detects four symbols from signals received during four time slots through the antenna 112 using the valid channels received from the channel estimator 114.

The above conventional MIMO system using quasi-orthogonal STC for four transmit antennas adopts the ABBA or Jafarkhani scheme for coding. However, these two schemes commonly reduce a diversity gain, despite no loss in data rate. The quasi-orthogonal STC offers a maximal diversity gain because of no Inter-Symbol Interference (ISI). Nonetheless, the quasi-orthogonal nature of the ABBA or Jafarkhani scheme leads to ISI. As a consequence, instead of a full diversity gain, a diversity gain of 2 being a half of the number of transmit antennas is obtained. Moreover, to achieve the diversity gain of 2, the detector 116 of the receiver 110 should be an ML detector. Despite the benefit of optimal system performance, the ML detector operates with a very high complexity during symbol detection.

As described above, the conventional MIMO system using the ABBA or Jafarkhani scheme suffers from loss in diversity gain due to ISI and high receiver complexity due to the requirement of an ML receiver.

### SUMMARY OF THE INVENTION

An aspect of the present invention is to address at least the above problems and/or disadvantages and to provide at least the advantages described below. Accordingly, an aspect of the present invention is to provide an apparatus and method for selecting an STC scheme in a MIMO system.

Another aspect of the present invention is to provide an apparatus and method for reducing loss in diversity gain by selecting an STC scheme in a MIMO system.

A further aspect of the present invention is to provide an apparatus and method for reducing loss in diversity gain by selecting an STC scheme according to a received feedback signal by a transmitter in a MIMO system.

Still another aspect of the present invention is to provide an apparatus and method for reducing loss in diversity gain by selecting an STC scheme by a receiver in a MIMO system.

Yet another aspect of the present invention is to provide an apparatus and method for selecting a scheme requiring a low-complexity linear detector by selecting an STC scheme with less interference by a receiver in a MIMO system.

According to one aspect of the present invention, a transmitter for selecting an STC scheme in a MIMO system is provided. A code selector receives a feedback signal from a receiver and selects an STC scheme indicated by the feedback signal, and an encoder encodes transmission data to symbols to be transmitted through antennas in the selected STC scheme.

According to another aspect of the present invention, a receiver for selecting an STC scheme in a MIMO system is provided. An antenna receives a signal that has experienced a fading channel, a channel estimator estimates channel information about transmit antennas using the received signal, and a code selector measures interference factors of available STC schemes using the estimated channel information, selects an STC scheme with a smallest interference factor from among the STC schemes for use in a next symbol transmission in a transmitter, and notifies the transmitter of the selected STC scheme by feedback information.

According to a further aspect of the present invention, a method in a transmitter for selecting an STC scheme in a MIMO system is provided. The transmitter receives a feedback signal from a receiver, selects an STC scheme indicated by the feedback signal, encodes transmission data to symbols to be transmitted through antennas in the selected STC scheme, and transmits the symbols to the receiver.

According to still another aspect of the present invention, a method in a receiver for selecting an STC scheme in a MIMO system is provided. Upon receipt of a signal that has experienced a fading channel from a transmitter, the receiver estimates channel information about transmit antennas using the received signal, measures interference factors of available STC schemes using the estimated channel information, selects an STC scheme with a smallest interference factor from among the STC schemes for use in a next symbol transmission in the transmitter, and notifies the transmitter of the selected STC scheme by feedback information.

According to a still further aspect of the present invention, a transmitter for selecting an STC scheme in a MIMO system is provided. A code selector receives a feedback signal from a receiver and selects an STC scheme according to interference factors of available STC schemes included in the feedback signal, and an encoder encodes transmission data to symbols to be transmitted through antennas in the selected STC scheme.

According to yet another aspect of the present invention, a receiver for selecting an STC scheme in a MIMO system is provided. An antenna receives a signal that has experienced a fading channel, a channel estimator estimates channel information about transmit antennas using the received signal, and a code selector measures interference factors of available STC schemes using the estimated channel information and notifies the transmitter of the interference factors by feedback information.

According to yet a further aspect of the present invention, a method in a transmitter for selecting an STC scheme in a MIMO system is provided. The transmitter receives a feedback signal from a receiver, selects an STC scheme by comparing interference factors of available STC schemes included in the feedback signal, encodes transmission data to symbols to be transmitted through antennas in the selected STC scheme, and transmits the symbols to the receiver.

According to yet still another aspect of the present invention, a method in a receiver for selecting an STC scheme in a MIMO system is provided. Upon receipt of a signal that has experienced a fading channel from a transmitter, the receiver estimates channel information about transmit antennas using the received signal, measures interference factors of available STC schemes using the estimated channel information, and notifies the transmitter of the interference factors by feedback information.

### BRIEF DESCRIPTION OF THE DRAWINGS

The above and other aspects, features and advantages of certain exemplary embodiments of the present invention will become more apparent from the following detailed description when taken in conjunction with the accompanying drawings in which:

FIG. 1 illustrates a conventional MIMO system;

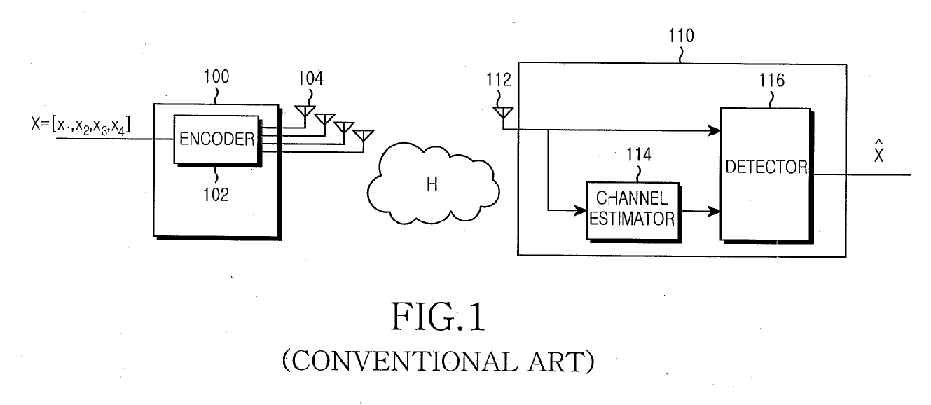

FIG. 2 is a block diagram for selecting an STC scheme in a MIMO system according to an exemplary embodiment of the present invention;

FIG. 3 is a flowchart illustrating an operation in a transmitter for encoding data in an STC scheme selected by a receiver and transmitting the STC data in the MIMO system according to an exemplary embodiment of the present invention;

FIG. 4 is a flowchart illustrating an operation in the receiver for selecting an STC scheme according to channel status and detecting symbols in the MIMO system according to an exemplary embodiment of the present invention;

FIG. 5 is a flowchart illustrating an operation in the transmitter for selecting an STC scheme, encoding data in the STC scheme, and transmitting the STC data in the MIMO system according to an exemplary embodiment of the present invention;

FIG. 6 is a flowchart illustrating an operation in the receiver for detecting symbols in an STC scheme selected based on channel status in the MIMO system according to an exemplary embodiment of the present invention; and

FIG. 7 is a graph comparing an exemplary embodiment of the present invention with conventional codes in terms of performance.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of the exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, following descriptions of well-known functions and constructions are omitted for clarity and conciseness.

The present invention provides an apparatus and method for improving spatial diversity by selecting an STC scheme in a MIMO system. For a MIMO system with four transmit antennas at a transmitter and one receive antenna at a receiver, the receiver selects an STC scheme between the ABBA scheme and the Jafarkhani scheme. Channel matrices are given for the ABBA scheme and the Jafarkhani scheme as follows.

$${H}_{ABBA} = [ \begin{matrix}{h}_{1} & {h}_{2} & {h}_{3} & {h}_{4} \\ - {h}_{2}^{*} & {h}_{1}^{*} & - {h}_{4}^{*} & {h}_{3}^{*} \\ {h}_{3} & {h}_{4} & {h}_{1} & {h}_{2} \\ - {h}_{4}^{*} & {h}_{3}^{*} & - {h}_{2}^{*} & {h}_{1}^{*}\end{matrix} ] \\ {H}_{jafarkhani} = [ \begin{matrix}{h}_{1} & {h}_{2} & {h}_{3} & {h}_{4} \\ - {h}_{2}^{*} & {h}_{1}^{*} & - {h}_{4}^{*} & {h}_{3}^{*} \\ - {h}_{3}^{*} & - {h}_{4}^{*} & {h}_{1}^{*} & {h}_{2}^{*} \\ {h}_{4} & - {h}_{3} & - {h}_{2} & {h}_{1}\end{matrix} ] \qquad ( 2 )$$

where H_{ABBA} denotes the channel matrix generated in the ABBA scheme, H_{jafarkhani} denotes the channel matrix generated in the Jafarkhani scheme, and hᵢ (i=1, 2, 3, 4) denotes a channel coefficient between an i^{th} transmit antenna and the receive antenna.

As noted from Equation (2), despite the same channel environment, different channel matrices are derived in different STC schemes. From Equation (2), the following channel correlation matrices are obtained for the ABBA scheme and the Jafarkhani scheme.

$${H}_{ABBA}^{H} {H}_{ABBA} = [ \begin{matrix}g & 0 & {I}_{ABBA} & 0 \\ 0 & g & 0 & {I}_{ABBA} \\ {I}_{ABBA} & 0 & g & 0 \\ 0 & {I}_{ABBA} & 0 & g\end{matrix} ] \\ {H}_{Jafarkhani}^{H} {H}_{Jafarkhani} = [ \begin{matrix}g & 0 & 0 & {I}_{Jaf} \\ 0 & g & {I}_{Jaf} & 0 \\ 0 & {I}_{Jaf} & g & 0 \\ {I}_{Jaf} & 0 & 0 & g\end{matrix} ] \qquad ( 3 )$$

where

$$g = {\sum }_{i = 1}^{4} {\vert {h}_{i} \vert}^{2}$$

denotes the channel gain of each symbol, I_{ABBA}=h₁*h₃+h₁h₃*+h₂*h₄+h₂h₄* denotes a factor that causes interference to each symbol in the ABBA scheme, and I_{Jaf}=(h₁*h₄+h₁h₄*)−(h₂*h₃+h₂h₃*) denotes a factor that causes interference to each symbol in the Jafarkhani scheme.

Due to the interference factors I_{ABBA} and I_{Jaf}, as high a diversity gain as the number of antennas cannot be achieved conventionally. In contrast, an exemplary embodiment of the present invention mathematically derives different interference factors for each symbol according to the STC schemes under the same channel environment by Equation (3), for example. That is, the interference factors I_{ABBA} and I_{Jaf} cause different degrees of interference to the same symbol. Based on this fact, an exemplary embodiment of the present invention presents the following criterion by which the receiver can select an STC scheme with less interference between the ABBA scheme and the Jafarkhani scheme.
arg min(|I_{ABBA}|²,|I_{Jaf}|²) (4)
where I_{ABBA} denotes the interference factor in the ABBA scheme and I_{Jaf} denotes the interference factor in the Jafarkhani scheme.

The selection of an STC scheme with less interference based on the criterion described as Equation (4) increases the diversity gain of the system. That is, the decrease of ISI leads to the increase of a diversity gain that can be achieved using multiple antennas.

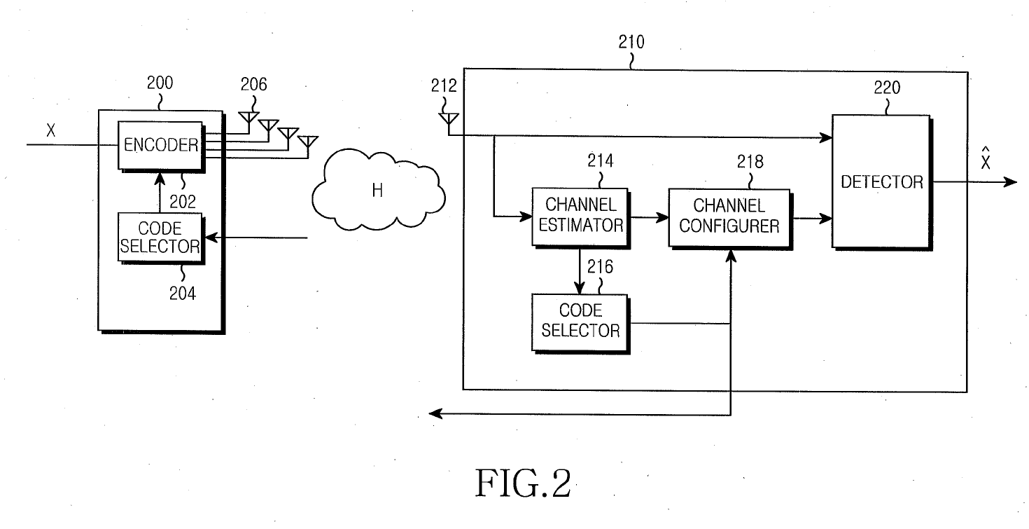

FIG. 2 is a block diagram for selecting an STC scheme in a MIMO system according to an exemplary embodiment of the present invention. Referring to FIG. 2, the MIMO system includes a transmitter 200 and a receiver 210.

The transmitter 200 has an encoder 202, a code selector 204, and antennas 206. The code selector 204 receives a feedback signal from the receiver 210 and selects an STC scheme according to the feedback signal. The feedback signal can be information about an STC scheme to be selected or the interference factors of STC schemes for use in selecting an STC scheme in the code selector 204. The STC schemes can be the ABBA scheme and the Jafarkhani scheme. The encoder 202 encodes transmission data in the selected STC scheme such that four code symbols can be transmitted through four transmit antennas 206 during four time slots. Then the code symbols are transmitted through the transmit antennas 206. If the feedback signal is information about the interference factors, the encoder 202 additionally transmits information about the STC scheme to the receiver 210. The STC scheme information may be carried on an additionally allocated channel.

The receiver 210 includes an antenna 212, a channel estimator 214, a code selector 216, a channel configurer 218, and a detector 220. The antenna 212 receives a signal that has experienced a fading channel. The channel estimator 214 estimates the channel statuses of the respective transmit antennas using the signal received through the antenna and provides the resulting channel information about the transmit antennas to the code selector 216 and the channel configurer 218. If receiving the information about the STC scheme selected by the transmitter 200 on the additionally allocated channel, the channel estimator 214 provides the STC scheme information to the channel configurer 218.

The code selector 216 measures the interference factors of the available STC schemes using the channel information and selects an STC scheme offering less interference for application to next symbols to be received according to Equation (4), and stores the selected STC scheme. The code selector 216 notifies the transmitter 200 of the selected STC scheme by feedback information. Also, the code selector 216 tells a stored STC scheme selected based on the previous channel information to the channel configurer 218. Alternatively, the code selector 216 may feedback information about the interference factors of the available STC schemes such as I_{ABBA} and I_{Jaf} defined in Equation (3) to the transmitter 200, instead of the selected STC scheme for use in the next symbol transmission.

The channel configurer 218 configures valid channels with respect to the signal received through the antenna 212 using the channel information received from the channel estimator 214 according to the STC scheme indicated by the code selector 216. If the transmitter 200 selects the STC scheme, the channel configurer 218 receives information about the selected STC scheme and configures the valid channels with respect to the received signal according to the selected STC scheme. According to the ABBA scheme or the Jafarkhani scheme, the valid channels can be configured using Equation (2).

The detector 220 simultaneously detects four symbols received through the antenna 212 during four time slots using the valid channels configured by the channel configurer 218. Because of interference reduction, the detector 220 can be a linear detector such as Zero-Forcing (ZF) or Minimum Mean Square Error (MMSE) detector.

Now a description will be made of a method for selecting an STC scheme in the MIMO system according to an exemplary embodiment of the present invention.

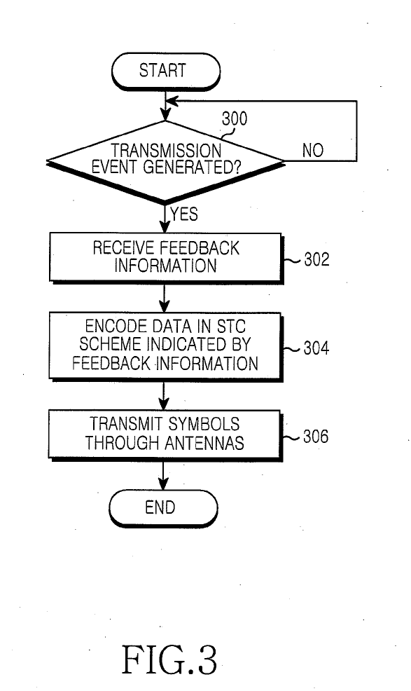

FIG. 3 is a flowchart illustrating an operation in a transmitter for encoding data in an STC scheme selected by the receiver and transmitting the STC data in a MIMO system according to an exemplary embodiment of the present invention.

Referring to FIG. 3, upon generation of a data transmission event in step 300, the transmitter 200 receives feedback information from the receiver 210 in step 302. The transmitter 200 generates symbols to be transmitted through the respective transmit antennas by encoding transmission data in an STC scheme corresponding to the feedback information in step 304 and transmits the symbols to the receiver 210 in step 306.

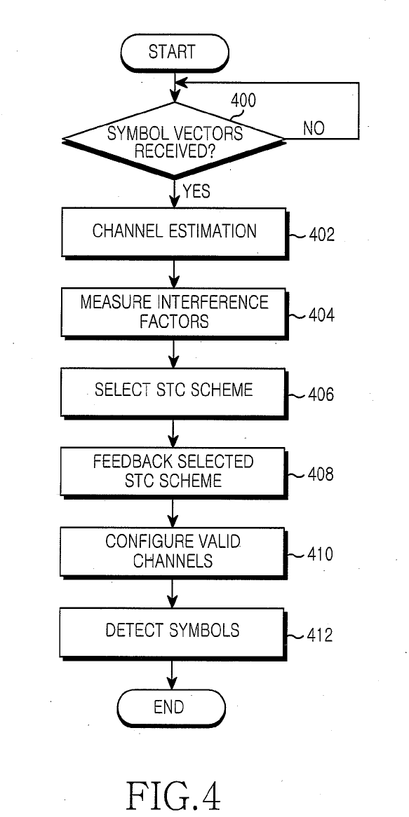

FIG. 4 is a flowchart illustrating an operation in a receiver for selecting an STC scheme according to channel status and detecting symbols in a MIMO system according to an exemplary embodiment of the present invention.

Referring to FIG. 4, upon receipt of symbol vectors from the transmitter 200 in step 400, the receiver 210 estimates the channel statuses of the respective transmit antennas of the transmitter 200 using the symbol vectors in step 402. The receiver 210 measures the interference factors of the available STC schemes based on the channel estimates in step 404 and selects an STC scheme offering less interference from among the available STC schemes for application to the next symbol transmission in the transmitter 200 in step 406. In step 408, the receiver 210 stores the selected STC scheme and feeds it back to the transmitter 200. The receiver 210 then configures valid channels according to an STC scheme selected during the previous symbol vector reception in step 410 and detects four transmission symbols from the received symbol vectors using the valid channels in step 412.

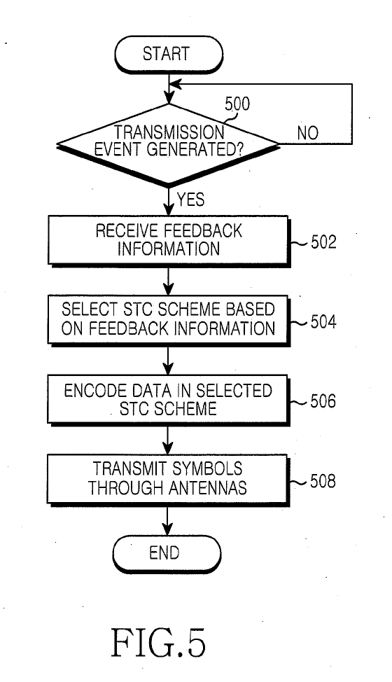

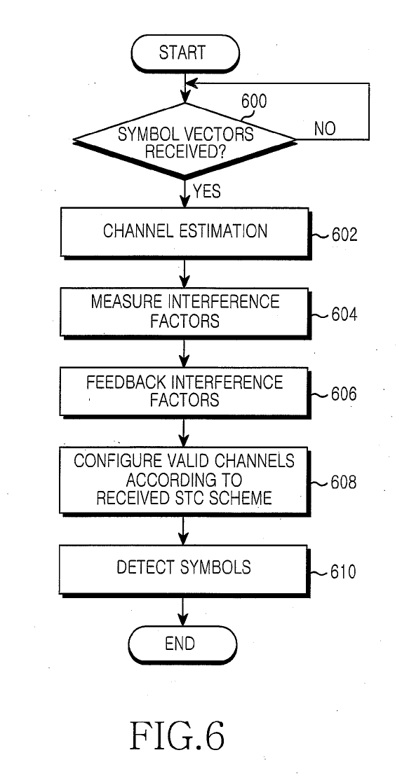

Another exemplary method for selecting an STC scheme in a MIMO system will be described below with reference to FIGS. 5 and 6.

FIG. 5 is a flowchart illustrating an operation in a transmitter for selecting an STC scheme, encoding data in a STC scheme, and transmitting STC data in a MIMO system according to an exemplary embodiment of the present invention.

Referring to FIG. 5, upon generation of a data transmission event in step 500, the transmitter 200 receives feedback information including information about the interference factors of the available STC schemes from the receiver 210 in step 502 and selects an STC scheme based on the interference factors in step 504. The transmitter 200 generates symbols to be transmitted through the respective transmit antennas by encoding transmission data in the selected STC scheme in step 506 and transmits the symbols to the receiver 210 in step 508. Also, information about the selected STC scheme is transmitted to the receiver 210 on an additionally allocated channel.

FIG. 6 is a flowchart illustrating an operation in a receiver for detecting symbols in an STC scheme selected based on channel status in a MIMO system according to an exemplary embodiment of the present invention.

Referring to FIG. 6, upon receipt of symbol vectors from the transmitter 200 in step 600, the receiver 210 estimates the channel statuses of the respective transmit antennas of the transmitter 200 using the symbol vectors in step 602. The receiver 210 measures the interference factors of the available STC schemes based on the channel estimates in step 604 and feeds back the interference factors to the transmitter 200 in step 606. The receiver 210 then configures valid channels according to information about a transmitter-selected STC scheme received on an additionally allocated channel in step 608 and detects four transmission symbols from the received symbol vectors using the valid channels in step 610.

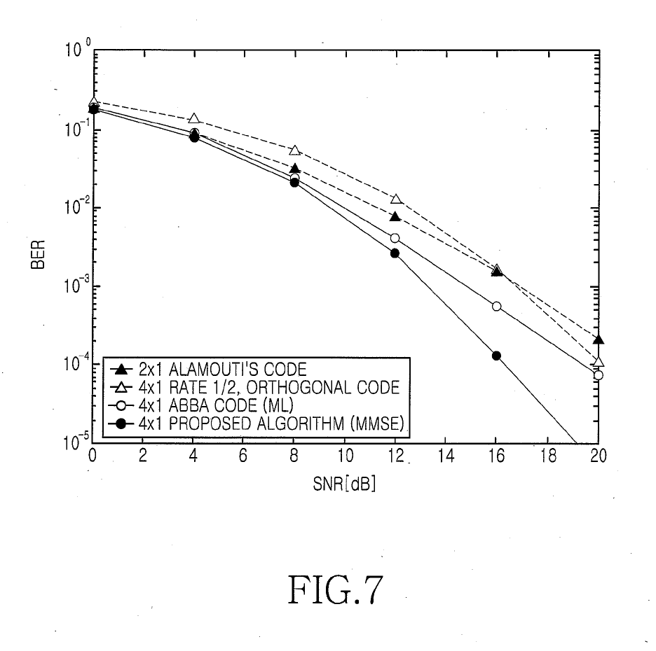

FIG. 7 is a graph comparing an exemplary embodiment of the present invention with conventional codes in terms of performance. In the illustrated case of FIG. 7, for a MIMO system with four transmit antennas and one receive antenna, the same transmit power is allocated to each antenna and the same data rate is used for each STC scheme. Herein, an independent Rayleigh fading channel is assumed. A comparison between the conventional codes with an exemplary embodiment of the present invention in terms of Bit Error Rate (BER) versus Signal-to-Noise Ratio (SNR) reveals that the conventional ABBA code requires an ML receiver and provides a diversity gain equal to that of a 2×1 Alamouti's code and smaller than a 4×1 orthogonal code. In contrast, an exemplary embodiment of present invention uses a linear MMSE receiver and achieves almost the same diversity gain as that of the 2×1 orthogonal code. Thus it can be concluded that an exemplary embodiment of the present invention has a higher diversity gain than the conventional technologies.

As described above, the present invention provides an apparatus and method for improving spatial diversity by selecting an STC scheme in a MIMO system. The present invention advantageously reduces loss in diversity gain despite the use of a simple linear detector at a receiver.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A transmitter for selecting a Space-Time Coding (STC) scheme in a Multiple-Input Multiple-Output (MIMO) system, comprising:
a code selector for receiving a feedback signal from a receiver, the feedback signal determining an STC scheme; and
an encoder for encoding transmission data to symbols to be transmitted through plural antennas in the STC scheme determined from the code selector.

2. The transmitter of claim 1, wherein the STC scheme determined by the code selector comprises at least one of an ABBA scheme and a Jafarkhani scheme.

3. The transmitter of claim 2, wherein the ABBA scheme or the Jafarkhani scheme denotes a scheme which reduces degrees of interference to each symbol.

4. The transmitter of claim 2, wherein the STC scheme is determined between the ABBA scheme and the Jafarkhani scheme with less interference degree.

5. The transmitter of claim 1, wherein the plural antennas are 4.

6. A receiver for selecting a Space-Time Coding (STC) scheme in a Multiple-Input Multiple-Output (MIMO) system, comprising:
an antenna for receiving a signal that has experienced a fading channel;
a channel estimator for estimating channel information about transmit antennas using the received signal; and
a code selector for deriving available STC schemes using the estimated channel information, for selecting an STC scheme with a smallest interference factor from among the STC schemes for use in a next symbol transmission in a transmitter, and for notifying the transmitter of the selected STC scheme.

7. The receiver of claim 6, wherein the code selector stores the selected STC scheme.

8. The receiver of claim 7, further comprising:
a channel configurer for configuring valid channels using the estimated channel information according to a previous STC scheme stored by the code selector; and
a detector for detecting symbols from the received signal using the valid channels.

9. The receiver of claim 7, wherein the code selector selects an STC scheme with a smaller interference factor between an ABBA scheme and a Jafarkhani scheme for use in the next symbol transmission in the transmitter.

10. The receiver of claim 9, wherein the code selector selects the STC scheme with the smaller interference factor between the ABBA scheme and the Jafarkhani scheme by
arg min(|I_{ABBA}|²,|I_{Jaf}|²)
where I_{ABBA} denotes an interference factor causing interference to each symbol in the ABBA scheme, I_{Jaf} denotes an interference factor causing interference to each symbol in the Jafarkhani scheme, I_{ABBA}=h₁*h₃+h₁h₃*+h₂*h₄+h₂h₄*, and I_{Jaf}=(h₁*h₄+h₁h₄*)−(h₂*h₃+h₂h₃*).

11. The receiver of claim 6, wherein the antenna is a single antenna.

12. The receiver of claim 8, wherein the detector is a linear detector comprising at least one of a Zero-Forcing (ZF) detector and a Minimum Mean Square Error (MMSE) detector.

13. A method in a transmitter for selecting a Space-Time Coding (STC) scheme in a Multiple-Input Multiple-Output (MIMO) system, the method comprising:
receiving a feedback signal from a receiver;
selecting an STC scheme indicated by the feedback signal;
encoding transmission data to symbols to be transmitted through antennas in the selected STC scheme; and
transmitting the symbols to the receiver.

14. The method of claim 13, wherein the selecting of the STC scheme comprises selecting at least one of an ABBA scheme and a Jafarkhani scheme.

15. A method in a receiver for selecting a Space-Time Coding (STC) scheme in a Multiple-Input Multiple-Output (MIMO) system, the method comprising:
estimating, upon receipt of a signal that has experienced a fading channel from a transmitter, channel information about transmit antennas using the received signal;
measuring interference factors of available STC schemes using the estimated channel information;
selecting an STC scheme with a smallest interference factor from among the STC schemes for use in a next symbol transmission in the transmitter; and
notifying the transmitter of the selected STC scheme by feedback information.

16. The method of claim 15, further comprising storing the selected STC scheme.

17. The method of claim 16, after the storing of the selected STC scheme, further comprising:
configuring valid channels using the estimated channel information according to a previous STC scheme stored by the code selector; and
detecting symbols from the received signal using the valid channels.

18. The method of claim 15, wherein the selecting of the STC scheme comprises selecting at least one of an ABBA scheme and a Jafarkhani scheme for use in the next symbol transmission in the transmitter.

19. The method of claim 18, wherein the selecting of the STC scheme comprises selecting the STC scheme with the smaller interference factor by
arg min(|I_{ABBA}|²,|I_{Jaf}|²)
where I_{ABBA} denotes an interference factor causing interference to each symbol in the ABBA scheme, I_{Jaf} denotes an interference factor causing interference to each symbol in the Jafarkhani scheme, I_{ABBA}=h₁*h₃+h₁h₃*+h₂*h₄+h₂h₄*, and I_{Jaf}=(h₁*h₄+h₁h₄*)−(h₂*h₃+h₂h₃*).

20. A transmitter for selecting a Space-Time Coding (STC) scheme in a Multiple-Input Multiple-Output (MIMO) system, comprising:
a code selector for receiving a feedback signal from a receiver and for selecting an STC scheme according to interference factors of available STC schemes included in the feedback signal; and
an encoder for encoding transmission data to symbols to be transmitted through antennas in the selected STC scheme.

21. The transmitter of claim 20, wherein the STC scheme selected by the code selector comprises at least one of an ABBA scheme and a Jafarkhani scheme.

22. The transmitter of claim 20, wherein the encoder transmits information about the selected STC scheme to the receiver on an additionally allocated channel.

23. A method in a transmitter for selecting a Space-Time Coding (STC) scheme in a Multiple-Input Multiple-Output (MIMO) system, comprising:
receiving a feedback signal from a receiver;
selecting an STC scheme by comparing interference factors of available STC schemes included in the feedback signal;
encoding transmission data to symbols to be transmitted through antennas in the selected STC scheme; and
transmitting the symbols to the receiver.

24. The method of claim 23, wherein the selecting of the STC scheme comprises selecting an STC scheme having a smaller interference factor between an ABBA scheme and a Jafarkhani scheme.

25. A method in a receiver for selecting a Space-Time Coding (STC) scheme in a Multiple-Input Multiple-Output (MIMO) system, comprising:
estimating, upon receipt of a signal that has experienced a fading channel from a transmitter, channel information about transmit antennas using the received signal;
deriving available STC schemes using the estimated channel information; and
notifying the transmitter of the derived STC schemes.

26. The method of claim 25, after the notifying of the interference factors, further comprising:
configuring valid channels using the estimated channel information according to information about an STC scheme received on an additionally allocated channel; and
detecting symbols from the received signal using the valid channels.

27. The method of claim 25, wherein the measuring of the interference factor comprises measuring interference factors of at least one of an ABBA scheme and a Jafarkhani scheme.

28. The method of claim 27, wherein the measuring of interference factor comprises measuring the interference factors of the ABBA scheme and the Jafarkhani scheme by
I_{ABBA}=h₁*h₃+h₁h₃*+h₂*h₄+h₂h₄*, and I_{Jaf}=(h₁*h₄+h₁h₄*)−(h₂*h₃+h₂h₃*).
where I_{ABBA} denotes the interference factor of the ABBA scheme, I_{Jaf} denotes the interference of the Jafarkhani scheme, and hᵢ (i=1, 2, 3, 4) denotes a channel coefficient between an i^{th} transmit antenna and the receive antenna.

29. A computer-readable recording medium having recorded thereon a program for selecting a Space-Time Coding (STC) scheme in a Multiple-Input Multiple-Output (MIMO) system, comprising:
a first code segment, receiving a feedback signal from a receiver;
a second code segment, selecting an STC scheme indicated by the feedback signal;
a third code segment, encoding transmission data to symbols to be transmitted through antennas in the selected STC scheme; and
a fourth code segment, transmitting the symbols to the receiver.

30. A computer-readable recording medium having recorded thereon a program for selecting a Space-Time Coding (STC) scheme in a Multiple-Input Multiple-Output (MIMO) system, comprising:
a first code segment, estimating, upon receipt of a signal, channel information about transmit antennas using the received signal;
a second code segment, measuring interference factors of available STC schemes using the estimated channel information;
a third code segment, selecting an STC scheme with a smallest interference factor from among the STC schemes for use in a next symbol transmission in the transmitter; and
a fourth code segment, notifying the transmitter of the selected STC scheme by feedback information.
